(19) United States
(12) Patent Application Publication
(10) Pub. No.: US 2015/0250361 A1
(43) Pub. Date: Sep. 10, 2015

(54) Deformable Product Extraction Tool

(71) Applicant: Nedra Marion, Omaha, NE (US)

(72) Inventor: Nedra Marion, Omaha, NE (US)

(21) Appl. No.: 14/195,989

(22) Filed: Mar. 4, 2014

(51) Int. Cl. A47J 43/28

(52) U.S. Cl. CPC A47J 43/288; A47J 43/28

(57) ABSTRACT

A product extraction tool may include, but is not limited to: an inelastically deformable handle portion; and one or more product engaging portions coupled to the inelastically deformable handle portion. A product extraction tool may include, but is not limited to: a handle portion; at least one substantially planar structure coupled to a first end of the handle portion; and at least one structure defining a recess coupled to a second end of the handle portion. A system for extracting product from a container may include, but is not limited to: at least one container including a product; and at least one product extraction tool comprising, the at least one product extraction tool comprising: an inelastically deformable handle portion; and one or more product engaging portions coupled to the inelastically deformable handle portion.

### BACKGROUND

Various manufacturers, specifically cosmetics and food manufacturers, may package their products in widely varying configurations in their products. When the contents of a package are progressively removed, it may become progressively difficult for a user to extract the contents due to the configuration of the packaging. Because containers for various manufacturers may be configured differently, a content withdrawal tool (e.g. a spatula or scoop) may work for one container but not for another.

### SUMMARY

A deformable product extraction tool may include, but is not limited to: an at least partially deformable handle portion; and one or more product extraction portions.

### BRIEF DESCRIPTION OF THE DRAWINGS

The disclosure will become more fully understood from the following detailed description, taken in conjunction with the accompanying drawings, wherein like reference numerals refer to like elements, in which Figure Reference No:

FIG. 1 illustrates an environmental view of a deformable product extraction tool;

FIG. 2 illustrates a side view of a use of a deformable product extraction tool within a container;

FIG. 3 illustrates a side view of a use of a product extraction tool within a container;

FIG. 4 illustrates a side view of a deformable product extraction tool;

FIG. 5 illustrates a side view of a use of a deformable product extraction tool within a container;

FIG. 6 illustrates a cross-sectional view of a deformable product extraction tool; and

FIG. 7 illustrates a perspective view of a product extraction tool.

### DETAILED DESCRIPTION

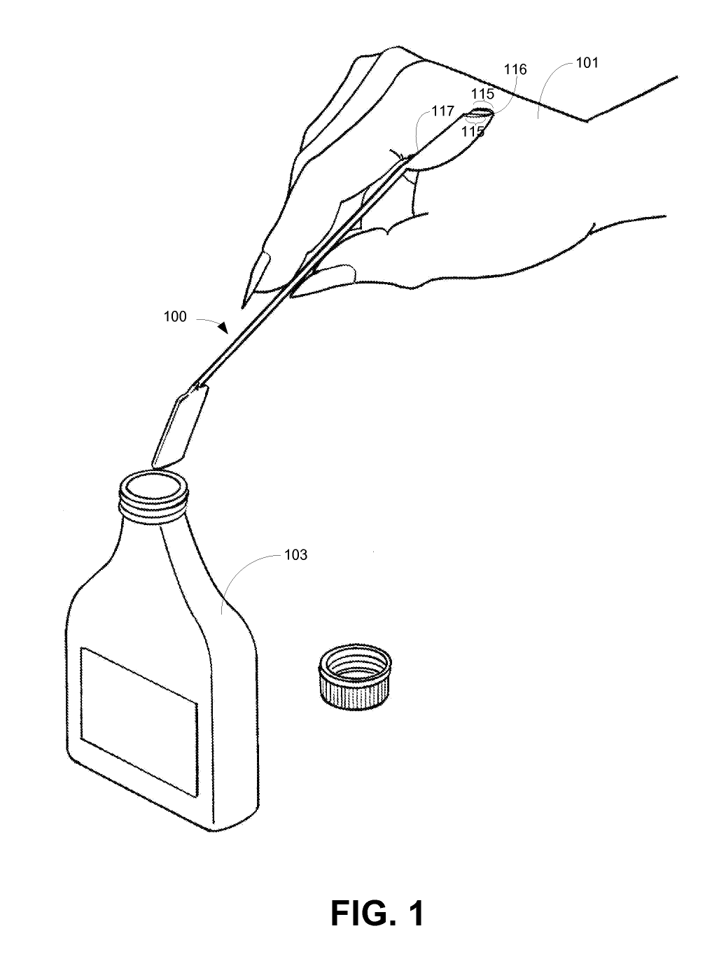

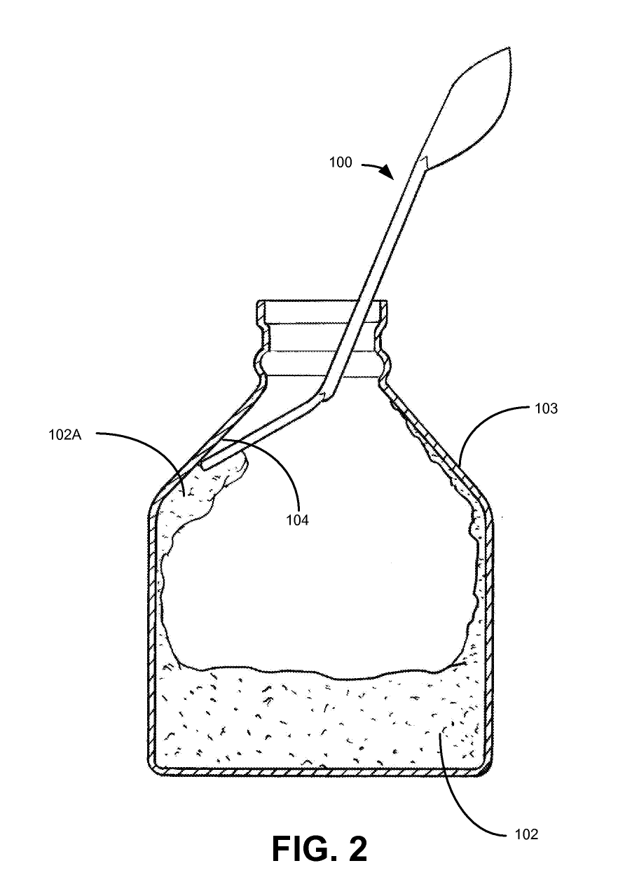

Referring to FIGS. 1 and 2, a product extraction tool 100 is shown. The product extraction tool 100 may be employed by a user 101 to extract a product 102 (e.g. cosmetics, food compositions, etc.) from a container 103. The product 102 may be semi-solid or gel-like in nature such that a portion of the product 102A may adhere to at least a portion of an inner wall 104 of the container 103.

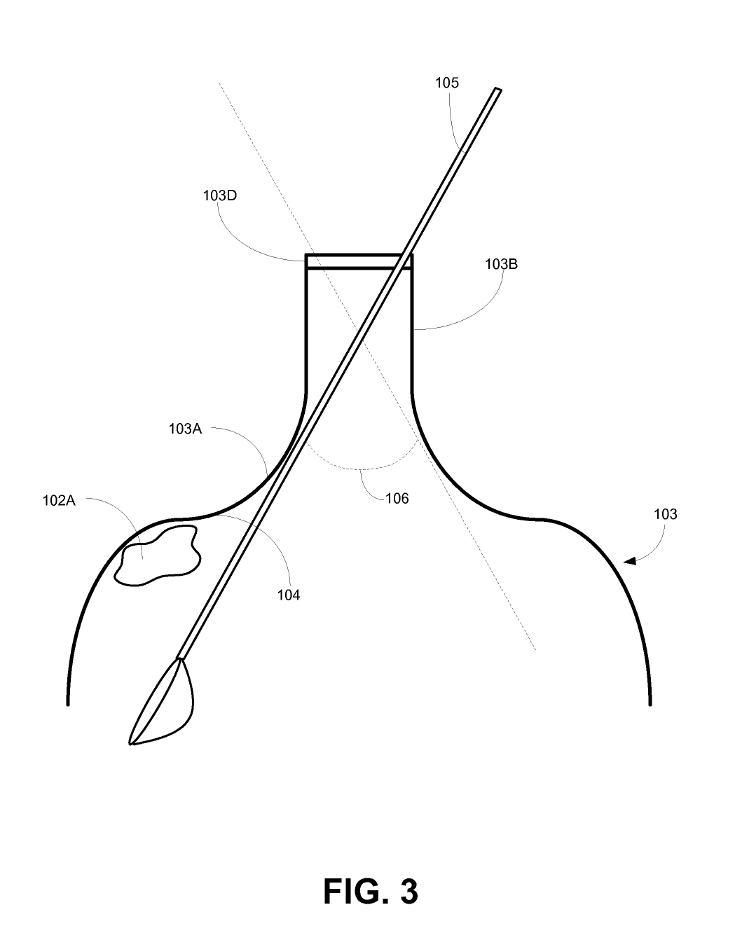

As shown in FIG. 3, it may be the case that the relative geometries of the container 103 may limit or prohibit access to certain portions of the container 103. For example, the container 103 may include a shoulder portion 103A substantially adjacent to a neck portion 103B. The shoulder portion 103A may be disposed at an angle approaching 90 degrees (e.g. from about 90 to 150 degrees) relative to the neck portion 103B. The neck portion 103B may have a mouth 103D through which product 102 may be extracted. The mouth 103D may have a diameter such that a rigid product extraction tool 105 (e.g. a statically configured spoon, scoop or spatula) cannot access product 102A disposed in the portion of the container 103 adjacent to the shoulder portion 103A.

For example, as shown in FIG. 3, the maximum deviation (relative to vertical) to which a rigid product extraction tool may be angled may be limited by the spatial relationship of the neck portion 1038 and the shoulder portion 103A of the container 103. The neck portion 1038 and the shoulder portion 103A of the container 103 may cooperatively limit the lateral movement of a rigid product extraction tool 105 such that the effective angle of access 106 to the interior of the container 103 is such that a rigid product extraction tool 105 may not capable of engaging a portion of the product 102A adhered to the inner wall 104 of the container 103 that is outside the angle of access 106.

As such, as shown in FIGS. 1-2 and 4-7, the product extraction tool 100 may be an at least partially deformable product extraction tool 100 in that the configuration of the product extraction tool 100 may be modified and substantially retained in order to increase the angle of access 106 relative to the interior of the container 103.

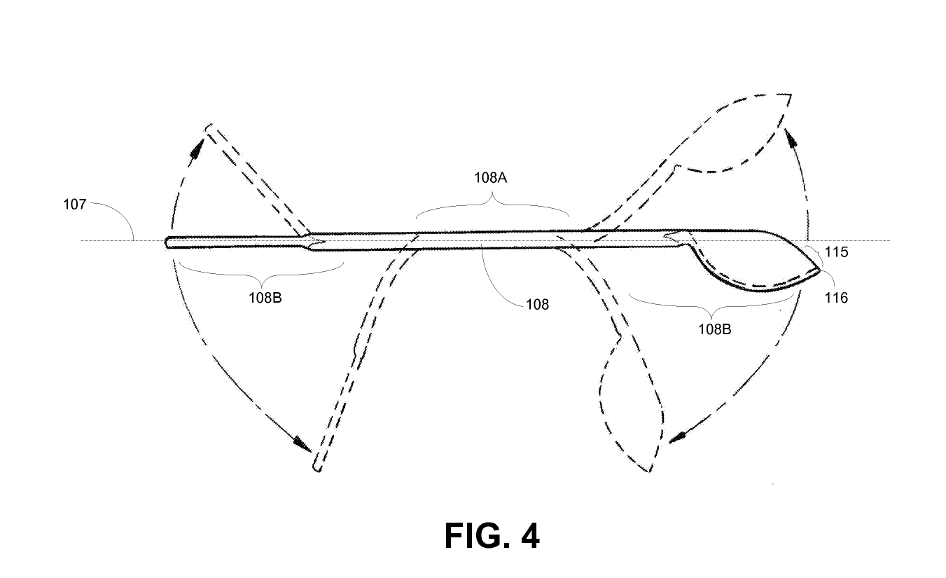

For example, as shown in FIG. 4, a deformable product extraction tool 100 may be constructed such that a portion of the deformable product extraction tool 100 may be deformed relative to a primary axis 107 defined by a handle portion 108 of the deformable product extraction tool 100. For example, a medial portion 108A of the handle portion 108 may be retained in a substantially linear configuration to facilitate gripping by the user 101 while one or more distal portions 108B may be bent into an angled or curved configuration relative to the medial portion 108A.

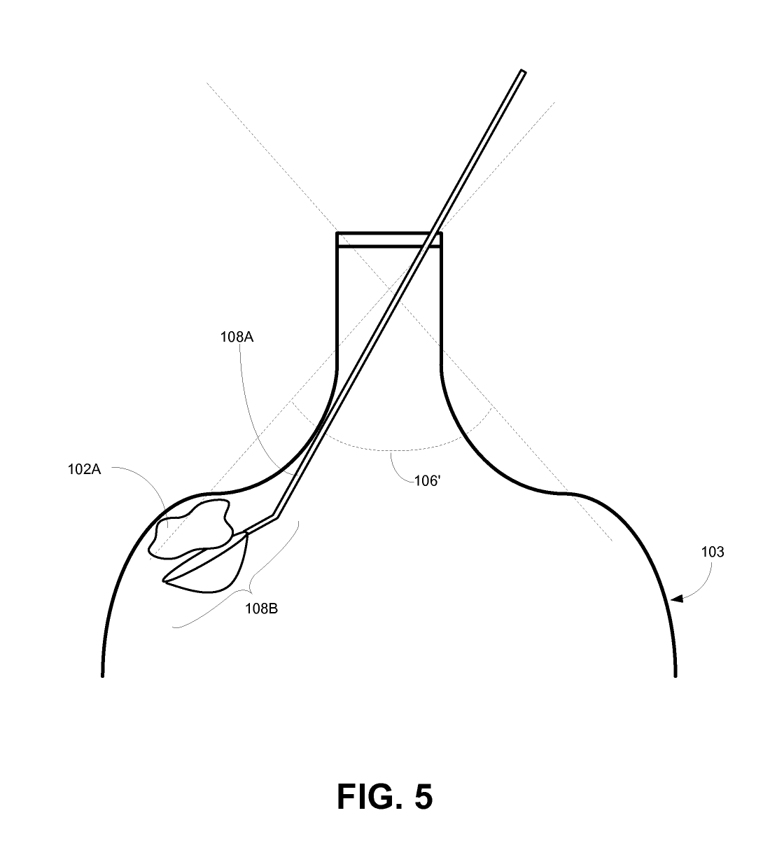

As shown in FIG. 5, the ability to position the distal portions 108B of the deformable product extraction tool 100 in a bent position relative to the medial portion 108A may facilitate extraction of a portion of product 102A adhering to the inner wall 104 outside of the angle of access 106 available to a rigid product extraction tool 105 as shown in FIG. 3 thereby increasing the effective angle of access 106′ to that shown in FIG. 5. This ability to access the portion of product 102A adhering to the inner wall 104 which would otherwise be inaccessible may serve to maximize the amount of product 102 that may be extracted from the container 103 thereby minimizing waste.

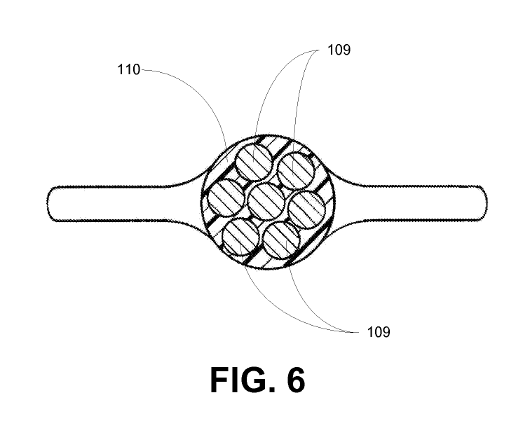

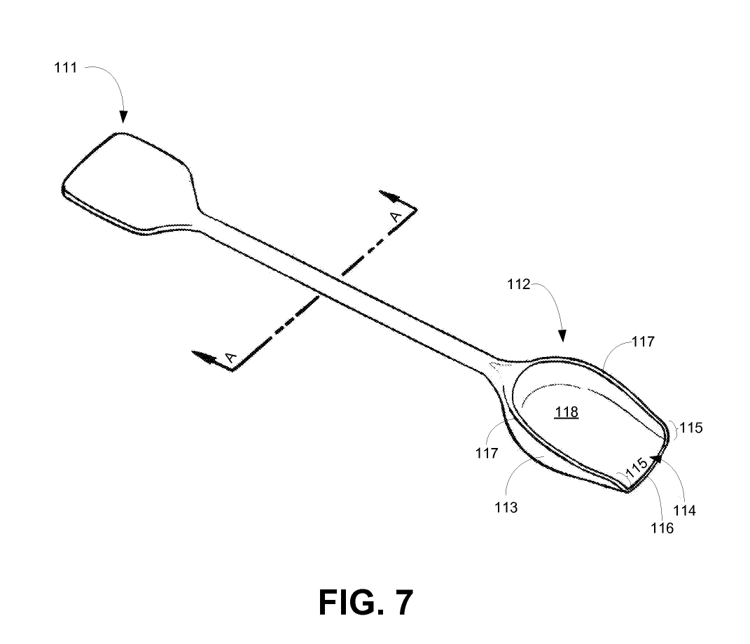

In an exemplary embodiment, the deformable product extraction tool 100 may be inelastically deformable such that, upon movement of a distal portion 108B of the deformable product extraction tool 100 relative to the medial portion 108A resulting from an application of pressure sufficient to translate the distal portion 108B, the distal portion 108B may be substantially retained in the bent position following the withdrawal of the pressure. For example, FIG. 6 depicts a cross sectional view of the handle portion 108 the deformable product extraction tool 100 along the axis A-A of FIG. 7. The handle portion 108 may include one or more inelastically deformable members 109. The inelastically deformable members 109 may be selected from any composition exhibiting inelastically deformable characteristics. For example, the inelastically deformable members 109 may include metal wires (e.g. steel, aluminum, and the like), plastics, and the like. In an exemplary embodiment, the inelastically deformable members 109 may include a plurality of the inelastically deformable members 109 disposed within a coating 110. The coating 110 may be a rubber coating, silicone coating or other bendable composition. While various configurations of the handle portion 108 have been depicted herein, such configurations are merely exemplary in nature in that the spatula portion 111 may have any cross-sectional configuration (e.g. rounded, rectangular, planar, etc.) and sizing (e.g. varying widths and lengths) suited for extraction of product from a particular container.

In an additional exemplary embodiment, a product extraction tool 100 may include a product engaging portion such as a spatula portion 111 (e.g. a structure having a substantially planar configuration) and/or scoop portion 112 (e.g. a structure having one or more wall portions defining a recess) coupled to an end of the product extraction tool 100. For example, as shown in FIGS. 1, 2, 4 and 7, the product extraction tool 100 may include both the spatula portion 111 and the scoop portion 112.

In various embodiments, the spatula portion 111 may include a substantially rigid structure (e.g. a hardened thermoplastic) or an at least partially flexible structure (e.g. a rubber or silicone structure). In another example, the scoop portion 112 may include a substantially arcuate portion 113 terminating in an aperture 114 formed by two sidewall edges 115 and a bottom edge 116 all in a co-planar configuration. The bottom edge 116 may be at least partially arcuate as in FIG. 1 or substantially linear as in FIG. 7. The aperture 114 may define a plane different than that of the primary edges 117 defining the recess 118 of the scoop portion 112. The planar nature of the aperture 114 may allow a large portion of the two co-planar sidewall edges 115 and/or the co-planar bottom edge 116 to simultaneously contact the inner wall 104 of the container 103 to enhance the effective contact area with the product 102A disposed on a inner wall 104 of the container 103. While various configurations of the spatula portion 111 have been depicted herein, such configurations are merely exemplary in nature in that a spatula portion 111 may have any configuration (e.g. planar, arcuate, scooped, etc.) and sizing (e.g. varying widths and lengths) suited for extraction of product from a particular container. For example, the spatula portion 111 may have a sizing configured to be as large as possible while still being receivable in the mouth 103D of a given container 103.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed:

1. A product extraction tool comprising:
an inelastically deformable handle portion; and
one or more product engaging portions coupled to the inelastically deformable handle portion.

2. The product extraction tool of claim 1, wherein the inelastically deformable handle portion includes:
a plurality of inelastically deformable members.

3. The product extraction tool of claim 2, wherein the inelastically deformable handle portion includes:
a coating at least partially encompassing the plurality of inelastically deformable members

4. The product extraction tool of claim 1, wherein at least one product engaging portion includes:
at least one substantially planar structure.

5. The product extraction tool of claim 4, wherein the at least one substantially planar structure includes:
an at least partially flexible structure.

6. The product extraction tool of claim 4, wherein the at least one substantially planar structure includes:
an at least partially rigid structure.

7. The product extraction tool of claim 1, wherein at least one product engaging portion includes:
at least one structure defining a recess.

8. The product extraction tool of claim 7, wherein the at least one structure defining a recess includes:
at least a first substantially planar edge defining a first plane and a second substantially planar edge defining a second plane different from the first plane.

9. The product extraction tool of claim 1, wherein the one or more product engaging portions include:
at least one substantially planar structure; and
at least one structure defining a recess.

10. The product extraction tool of claim 9, wherein the at least one substantially planar structure coupled to a first end of the inelastically deformable handle portion and the at least one structure defining a recess is coupled to a second end of the inelastically deformable handle portion.

11. A product extraction tool comprising:
a handle portion;
at least one substantially planar structure coupled to a first end of the handle portion; and
at least one structure defining a recess coupled to a second end of the handle portion.

12. The product extraction tool of claim 11, wherein the at least one substantially planar structure includes:
an at least partially flexible structure.

13. The product extraction tool of claim 11, wherein the at least one substantially planar structure includes:
an at least partially rigid structure.

14. The product extraction tool of claim 11, wherein the at least one structure defining a recess includes:
at least a first substantially planar edge defining a first plane and a second substantially planar edge defining a second plane different from the first plane.

15. A system for extracting product from a container comprising:
at least one container including a product; and
at least one product extraction tool comprising, the at least one product extraction tool comprising:
an inelastically deformable handle portion; and
one or more product engaging portions coupled to the inelastically deformable handle portion.

16. The product extraction tool of claim 15, wherein the product includes:
at least one of a semi-solid product or a gel product.

17. The product extraction tool of claim 15, wherein the inelastically deformable handle portion includes:
a plurality of inelastically deformable members.

18. The product extraction tool of claim 17, wherein the inelastically deformable handle portion includes:
a coating at least partially encompassing the plurality of inelastically deformable members

19. The product extraction tool of claim 15, wherein at least one product engaging portion includes:
at least one substantially planar structure.

20. The product extraction tool of claim 15, wherein at least one product engaging portion includes:
at least one structure defining a recess.
